(19) United States
(12) Patent Application Publication
(10) Pub. No.: US 2007/0177051 A1
(43) Pub. Date: Aug. 2, 2007

(54) Multifunction camera assembly for a computer

(76) Inventor: Shih-Ying Hsiao, San Chung City (TW)

Correspondence Address: RABIN & Berdo, PC, 1101 14TH STREET, NW, SUITE 500, WASHINGTON, DC, 20005, US

(21) Appl. No.: 11/341,473

(22) Filed: Jan. 30, 2006

(51) Int. Cl. H04N 5/225

(52) U.S. Cl. 348/373

(57) ABSTRACT

A multifunction camera assembly for a computer is provided, which includes a computer video camera and a computer peripheral. The computer peripheral is pivotally connected to the computer video camera, which may be rotated to change its angle and position relative to the computer video camera. Thus the computer video camera and the computer peripheral change their arrangement relationship according to the requirement of a user, to achieve a desirable operation mode.

### BACKGROUND OF THE INVENTION

1. Field of Invention

The present invention relates to a computer video camera, and more particularly, to a computer video camera to which a computer peripheral is connected, to provide additional functions.

2. Related Art

A computer video camera is a computer peripheral which is essential for carrying out video communication between peers connected by the Internet. The computer video camera is used for capturing the image of a user in front of a computer, and transmitting it to another computer via the Internet or a communication network. Recently, improvements to the computer video camera are mostly directed to the clamping structure or supporting structure. For example, U.S. Pat. No. 6,845,954 provides a clamping structure of a computer video camera for clamping the computer video camera on a flat-panel display, or supporting it on a plane.

Generally, the computer video camera is used for capturing images, and if the user wants to have a dialogue with a remote user via the Internet or the communication, a speaker and a microphone should be equipped to the computer, for inputting and outputting voice.

Besides capturing audio-video, a Universal Serial Bus (USB) hub, a card reader, and a fingerprint identification device are also required by a computer user, such that a number of wires should be connected to the computer for equipping those peripherals, and so many wire may wrap with each other, which causes inconvenience for the user. Also, various peripherals, including video cameras, speakers, microphones, USB hubs, card readers, fingerprint identification devices, and the like, have different relative positions or directions to cater to the habits of the user. If these peripherals are simply integrated into a single device, inconveniences for user will occur. Therefore, it has become an important technical issue to integrate different functions together, while meeting the operation habits or requirements of the user.

### SUMMARY OF THE INVENTION

In view of the above problems, an object of the present invention is to provide a video camera with additional computer peripherals, capable of expanding its function and changing angles through the relative pivotal rotation of the elements, such that the expanded functions are more convenient for use. In order to achieve the above object, the present invention provides a multifunction video camera assembly for a computer, which includes a computer video camera and a computer peripheral, wherein the computer peripheral is pivotally connected to the computer video camera, such that the relative position and angle can be changed; therefore, the computer peripheral can change its relative position or direction properly according to the requirements of the user, for facilitating the use thereof.

The advantages of the present invention lies in that, the computer video camera is integrated with various types of computer peripheral, such that its functions can be expanded, and the number of peripherals externally connected to the computer can be reduced. Meanwhile, the computer video camera and the computer peripheral can change the angle and relative position respectively through rotating relatively and pivotally, such that the computer video camera and the computer peripheral are provided for facilitating the use at the same time.

The features and practices of the present invention will be described in detail below through preferred embodiments with reference to accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and which thus is not limitative of the present invention, and wherein:

FIG. 1 is an exploded view of a first embodiment of the present invention;

FIG. 2 is a schematic view of the computer video camera and the computer peripherals in the first embodiment of the invention;

FIG. 3 is a sectional view of the first embodiment pf the invention;

FIG. 4 and FIG. 5 are perspective view of the first embodiment with different implementing aspects;

FIG. 6 is another perspective view of the first embodiment of the invention;

FIG. 7 is a perspective view of a second embodiment of the invention;

FIG. 8 is a perspective view of a third embodiment of the invention;

FIG. 9 is a perspective view of a fourth embodiment of the invention;

FIG. 10 is a perspective view of a fifth embodiment of the invention; and

FIG. 11 is a perspective view of a sixth embodiment of the invention.

### DETAILED DESCRIPTION OF THE INVENTION

The multifunction video camera assembly of the present invention can be connected to a computer, such as, a desktop computer or a notebook, to output image signals, and equipped with additional peripheral interfaces to provide the additional functions of various computer peripherals.

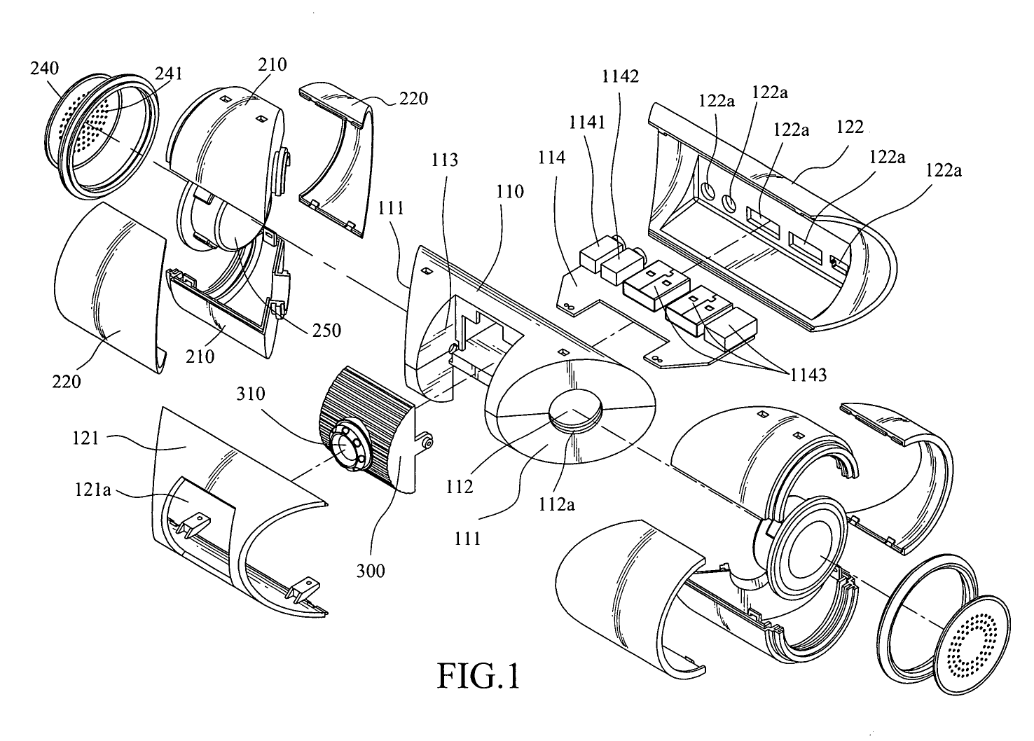

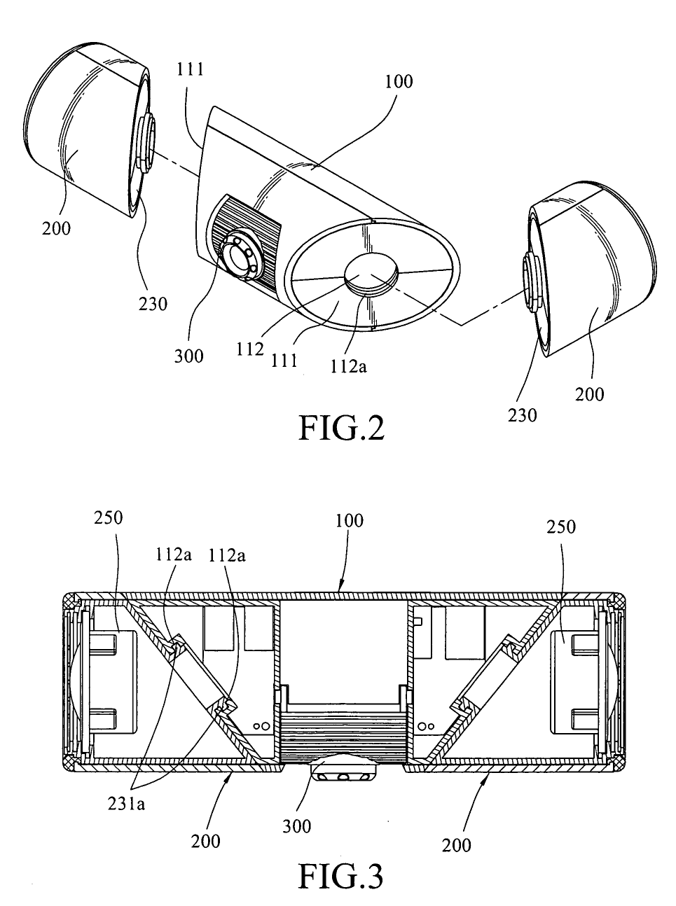

Referring to FIG. 1, FIG. 2, and FIG. 3, a multifunction video camera assembly according to a first embodiment of the present invention is provided. The multifunction video camera assembly includes a computer video camera 100 and two computer peripherals 200, wherein the computer video camera 100 and the computer peripherals 200 are column shaped. However, the shape is not limited to this, and other various shapes also can be used. Also, in the present embodiment, each of the computer peripherals 200 is a speaker, and it is also may be a microphone, a wireless receiver, a USB hub, a fingerprint identification device, a card reader, a ion generator, and the like.

The computer video camera 100 includes an inner frame 110, two housings 121 and 122, and a video camera unit 300, wherein the inner frame 110 is provided with a first bevel surface 111 respectively on both ends of the computer video camera 100, and the first bevel surface 111 forms an inclined angle with the central axis of the computer video camera 100. A shaft hole 112 is formed on the first bevel surface 111, and an annular groove 112a is provided on the inner wall of the shaft hole 112. The inner frame 110 is formed with a pivot base 113, to which the video camera unit 300 is pivotally connected, so that the video camera unit 300 is pivotally disposed in the computer video camera 100, and a camera lens 310 of the video camera unit 300 is exposed to the outside through an opening 121a of the housing 121.

Also, several expansion interfaces are disposed in the computer video camera 100 for expanding the function of the computer video camera 100. A circuit board 114 is disposed in the computer video camera 100, and the expansion interfaces are disposed on the circuit board 114. The expansion interface are exposed to the outside via through holes 122a of the image camera 100, wherein the through holes 122a has many configurations to match with various forms of expansion interfaces. The expansion interfaces can be an earphone socket 1141, a microphone socket 1142, and a USB Port 1143, which can be exposed to the outside via the through holes 122a for inserting an earphone, a microphone, or a USB wire. The USB Port 1143 is used to connect to the computer, for plugging in other computer peripherals, so that the present invention is provided with the function as a USB hub.

Each of the two computer peripherals 200 has two inner housings 210 and two outer housings 220, wherein an inner accommodation space is formed after the two inner housings 210 have been coupled with each other, and then the two inner housings 210 are wrapped by the two external housings 220 to change the appearance of the computer peripherals 200. A second bevel surface 230 is formed on one end of the computer peripheral 200, and a shaft 231 is protruded on the second bevel surface 230 perpendicularly, wherein a flange 231a is formed surrounding the circumference surface of the shaft 231. Moreover, the other end of the computer peripheral 200 is formed as a planar surface; and the planar surface is composed of a cover board 240 with meshes 241. A speaker unit 250 is disposed in the inner housing 210, which directs to the cover board within the computer peripheral 200, so as to produce sounds to the outside through the meshes 241, such that the computer peripheral 200 is formed as a speaker.

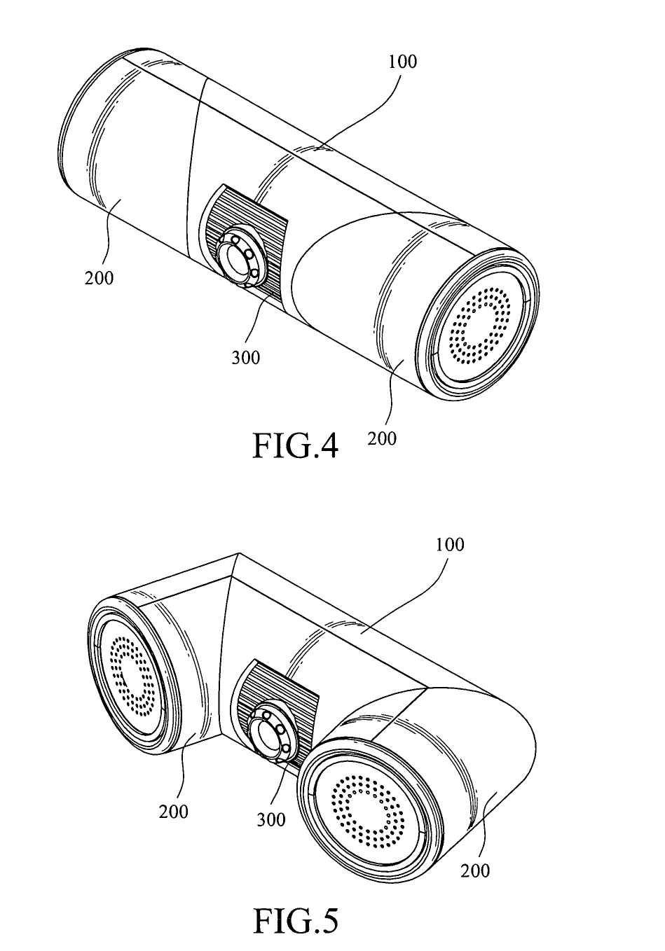

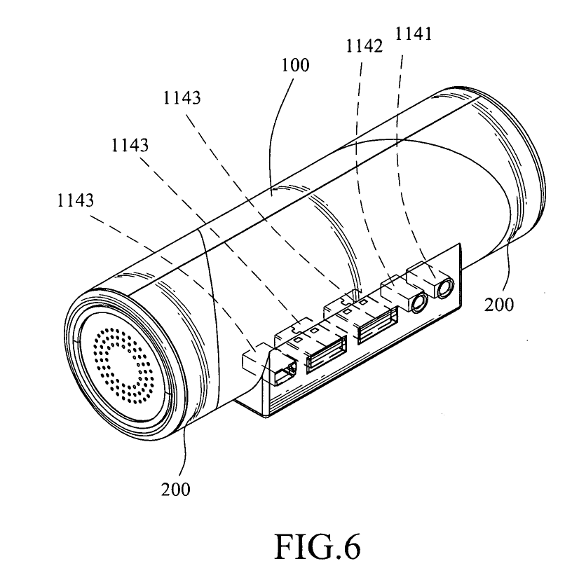

Referring to FIG. 4, FIG. 5, and FIG. 6, as for the assembling the multifunction video camera assembly the first embodiment of the of the invention, the shaft 231 of the computer peripheral 200 is first inserted into the shaft hole 112 of the computer video camera 100, so that the second bevel surfaces 230 of the two computer peripherals 200 get into contact with the first bevel surfaces 111 of the computer video camera 100 respectively; and each of the second bevel surfaces 230 is pivotally connected to one of the first bevel surfaces 111 of the computer video camera 100, such that the flange 231a on the shaft 231 can be embedded into the annular groove 112a of the shaft hole 112, thus, the computer peripheral 200 is pivotally connected to the computer video camera 100, and it can rotate relative to the computer video camera 100 without falling off. Through the relative rotation of the computer peripherals 200 and the computer video camera 100, the relative angle there-between can be changed, and the angle between the central axis of the computer peripheral 200 and the central axis of the computer video camera 100 also can be changed, such that the direction of the planar surface of one end of the computer peripheral 200 can be changed by rotating the computer peripheral 200 without moving the computer video camera 100, as shown in FIG. 5.

The computer video camera 100 and the computer peripheral 200 can relatively rotate along the first bevel surface 111 and the second bevel surface 230, so that there is an inclined angle relatively between the computer video camera 100 and the computer peripheral 200. This inclined angle is determined by the oblique angle of the first bevel surface 111 and the second bevel surface 230, the inclined angle between the i computer video camera 100 and the computer peripheral 200 after both of them have relatively rotated 180 degrees can be changed by changing the oblique angles. Of course, the relative angle between the image camera 100 and the computer peripheral 200 also can be changed gradually, such that the user can determine the desirable angle, and the multifunction camera assembly can be provided with various use configurations.

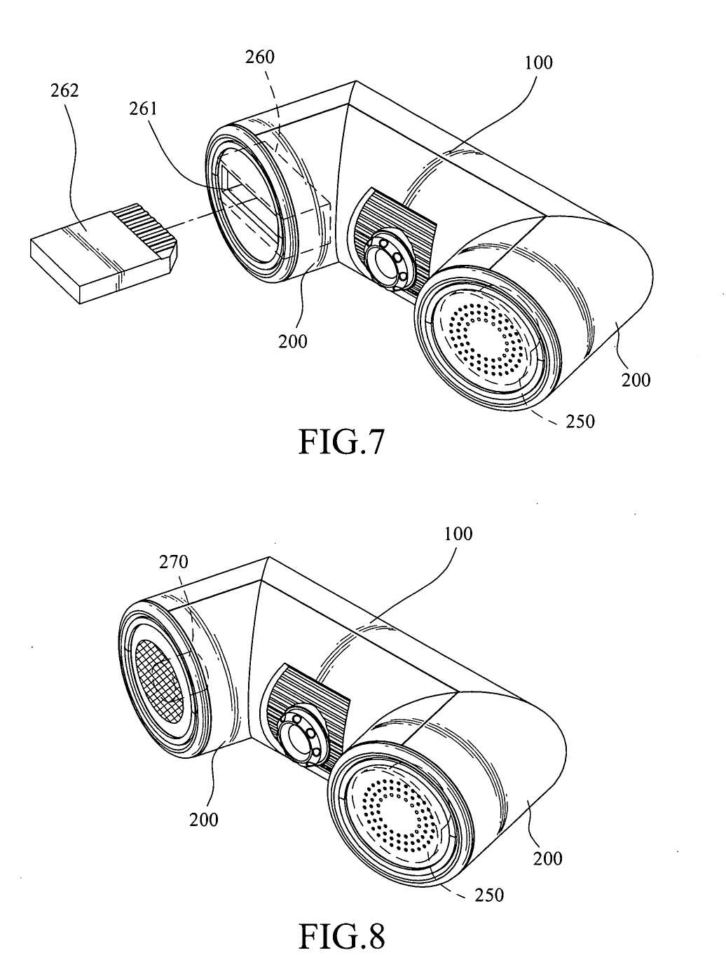

As shown in FIG. 7, a second embodiment of the present invention is provided, wherein the function of the computer peripheral 200 is not limited to the speaker, and other forms of peripheral interface devices also can be used to cater to the demanding of the user. In the second embodiment, a speaker unit 250 is disposed in one of the two computer peripherals 200 to form a speaker; a card reader module 260 is disposed in the other computer peripheral 200, then the computer peripheral 200 becomes a card reader. The card reader module 260 has a slot 261 for plugging in an electronic card 262, such as a flash card or a financial chip card with various specifications, to read data and transmit the data to the computer through the transmission wire. Through rotating the computer peripheral 200 according to the requirement of the user, the direction of the opening of the slot 261 can be turned to the direction suitable for operation.

Referring to FIG. 8, a third embodiment of the preset invention is provided. A speaker unit 250 is disposed in one of the two computer peripherals 200 to form a speaker; an audio receiver unit 270 is disposed in the other computer peripheral 200, such that the computer peripheral 200 becomes a microphone. Therefore, the multifunction camera assembly is provided with the functions of image capturing, sound broadcasting, audio receiving, and the like. Meanwhile, since the computer peripheral 200 can rotate relative to the image camera 100, the directions of the speaker unit 250 and the audio receiver unit 270 can be changed, such that both of them have preferred effects for receiving audio and broadcasting sounds.

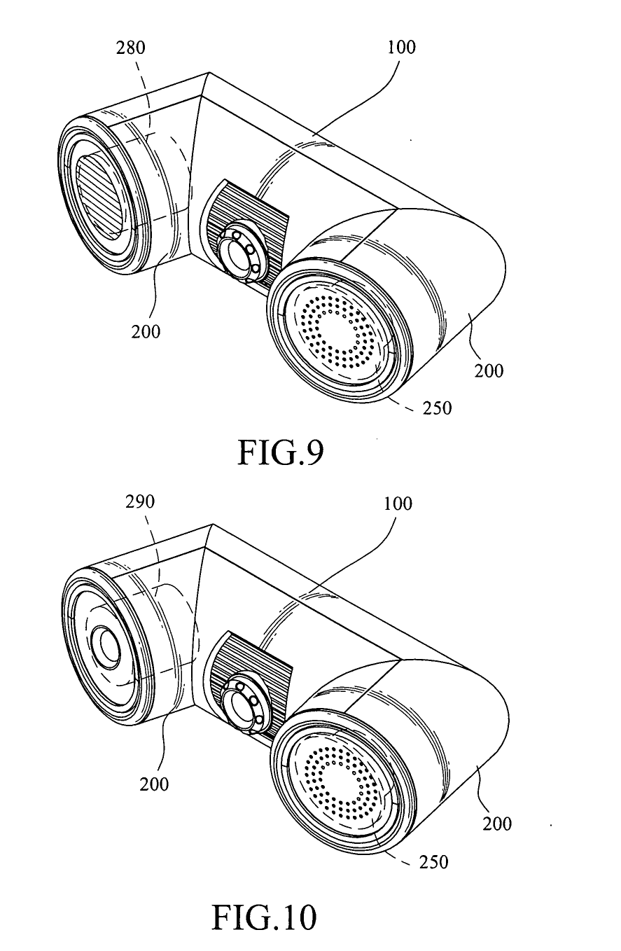

Referring to FIG. 9, a fourth embodiment of the present invention is provided. A speaker unit 250 is disposed in one of the two computer peripherals 200 to form a speaker; a fingerprint identification module 280 is disposed in the other computer peripheral 200, such that the computer peripheral 200 becomes a fingerprint identification device through this fingerprint identification module 280, thereby a user can carry out fingerprint identification, to protect the computer and to provide different authorization of different users for operating the computer.

Referring to FIG. 10, a fifth embodiment of the present invention is provided. A speaker unit 250 is disposed in one of the two computer peripherals 200 to form a speaker; an ion generating module 290 is disposed in the other computer peripheral 200, such that an ion generating effect can be achieved through this ion generating module 290. Therefore, the computer peripheral becomes an ion generator for improving the quality of the environment when a user operates the computer.

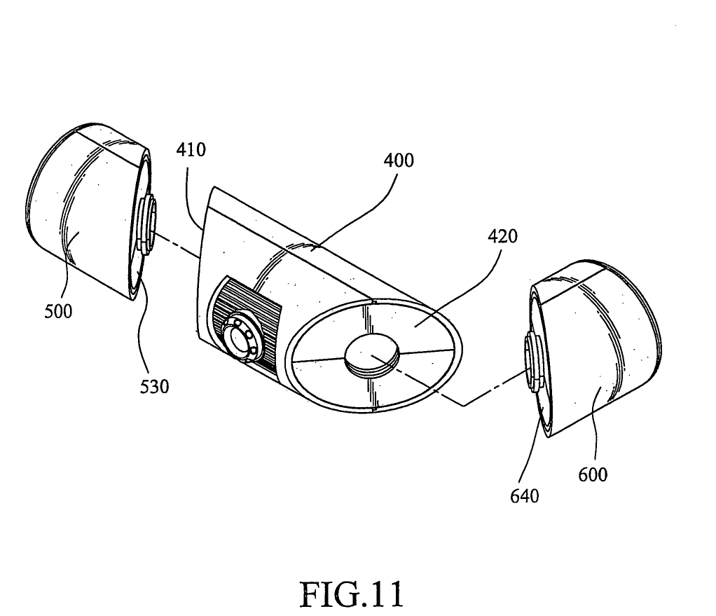

Referring to FIG. 11, a sixth embodiment of the present invention is provided, which includes a computer video camera 400, wherein one end of the computer video camera 400 has a first bevel surface 410, and the other end has a second bevel surface 420. Two computer peripherals 500, 600 with a third bevel surface 530 and a fourth bevel surface 640 respectively are provided, wherein the first bevel surface 410 is pivotally connected to the third bevel surface 530; the second bevel surface 420 is pivotally connected to the fourth bevel surface 640, such that the two computer peripherals 500, 600 are pivotally connected to both ends of the computer video camera 400.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multifunction camera assembly, comprising:
a computer video camera; and
at least one computer peripheral;
wherein, the computer video camera has a first bevel surface; the computer peripheral has a second bevel surface; and the computer peripheral is pivotally connected to the first bevel surface through the second bevel surface, such that the computer peripheral is rotated along the first bevel surface through the second bevel surface, thus changing the inclined angle between the computer video camera and the computer peripheral.

2. The multifunction camera assembly of claim 1, wherein the first bevel surface has a shaft hole, and a shaft is protruded on the second bevel surface perpendicularly, wherein the shaft is inserted into the shaft hole.

3. The multifunction camera assembly of claim 1, wherein the computer video camera has a pivot base and a video camera unit, and the video camera unit is pivotally connected to the pivot base for rotating relative to the pivot base.

4. The multifunction camera assembly of claim 3, wherein the computer video camera has an opening and the video camera unit is exposed to the outside through the opening.

5. The multifunction camera assembly of claim 1, further comprising at least one expansion interface disposed in the computer video camera.

6. The multifunction camera assembly of claim 5, wherein the expansion interface is one selected from the group consisting of an earphone socket, a microphone socket, and a

7. The multifunction camera assembly of claim 6, further comprising a circuit board disposed in the computer video camera, wherein the expansion interface is disposed on the circuit board.

8. The multifunction camera assembly of claim 1, wherein the computer peripheral is one selected from the group consisting of a speaker, a card reader, a fingerprint identification device, and a ion generator.

9. A multifunction camera assembly, comprising:
a computer video camera, with both ends pivotally connected to a computer peripheral respectively;
wherein one end of the computer video camera has a first bevel surface and the other end has a second bevel surface;
wherein, the two computer peripherals have a third bevel surface and a fourth bevel surface respectively;
wherein the first bevel surface is pivotally connected to the third bevel surface; and the second bevel surface is pivotally connected to the fourth bevel surface.
